(19) United States
(12) Patent Application Publication
(10) Pub. No.: US 2013/0239601 A1
(43) Pub. Date: Sep. 19, 2013

(54) HEAT PUMP WITH DOWNSTREAM SENSOR FOR MULTILEVEL CONTROL OF A SUPPLEMENTAL HEATING ELEMENT

(71) Applicant: Luther D. Albertson, Sellersburg, IN (US)

(72) Inventor: Luther D. Albertson, Sellersburg, IN (US)

(21) Appl. No.: 13/423,680

(22) Filed: Mar. 19, 2012

(51) Int. Cl. F25B 29/00; B23P 15/26

(52) U.S. Cl. 62/159; 29/890.035

(57) ABSTRACT

A heat pump having a supplemental resistive heat element that varies its heat output based on the air temperature downstream from it, rather than from the air temperature at the room thermostat or from the air temperature after the heat exchanger but before the variable supplemental resistive heating element.

### BACKGROUND OF THE INVENTION

The present invention relates to supplemental resistive heat systems used in heat pumps, particularly to a device that varies the supplemental heat output based on the air temperature downstream from a supplemental heating element, rather than the air temperature at the room thermostat.

Heat pump systems use a refrigerant to move thermal energy along a circulation loop from a relatively hot side to a relatively cold side. On the hot side, compression raises the temperature of the refrigerant and the excess heat is dissipated leaving the refrigerant under high pressure but somewhat cooler. The pressurized and partially cooled refrigerant is then allowed to expand in the cold side causing the refrigerant to absorb energy as it evaporates into a now cooler, lower pressure, gas. With the refrigerant again in a gaseous state, the cycle begins anew with compression.

In most residential settings, an air source heat pump system can accomplish either heating or cooling by selectively controlling the sequential flow of refrigerant through a series of valves and heat exchangers. In hot weather, an outdoor heat exchanger operates as the hot side of the loop dissipating excess heat of condensation into the air while an indoor heat exchanger cools the structure by absorbing heat as the refrigerant evaporates on the cold side. During the cooler months, the roles are reversed when the excess heat of condensation is dissipated from the indoor heat exchanger to heat the structure and the outdoor heat exchanger is used to evaporate the refrigerant liquid to gas.

However, air source heat pumps become ineffective when outdoor air temperatures become too low. As the difference between the air temperature and the refrigerant temperature narrows, it becomes more and more difficult for the outdoor heat exchanger to transfer thermal energy fast enough to keep pace with the thermal energy transferred to or from the structure. This problem is particularly pronounced in the colder months when many residential homes rely solely on a heat pump for warmth. As outdoor temperatures drop below freezing, it becomes increasingly difficult for an air source heat pump to move enough heat into the structure to offset thermal losses due to convection, conduction, and radiation.

When the heat pump cannot timely provide sufficient heat, a supplemental heating unit is activated to supply additional heat to maintain a comfortable indoor temperature. Conventional heat pump systems operating in a heating mode usually detect this condition using a two-stage room thermostat. When the room temperature falls below an initial set point, the heat pump compressor and fans activate and begin moving heat into the structure. If the heat pump moves heat into the structure faster than heat is lost, heat transfer will continue until the indoor temperature rises above the first set point and the thermostat deactivates the heat pump. If, however, the structure loses heat faster than the heat pump can replace it, the indoor air temperature will continue to drop until a second thermostat set point is reached. The second set point is usually automatically managed by the thermostat and is typically set a few degrees below the first set point. When the second set point is reached, the thermostat initiates a supplemental heating unit. This generally results in the activation of one or more electrical heating elements which further heats the supply air from the heat pump heat exchanger until the indoor room temperature is brought back up and the thermostat deactivates the system.

This cyclical behavior creates wide swings in the air temperature entering the living space from the heating system's supply ducts. Such wide temperature swings are generally uncomfortable and undesirable for the occupants. As the heat pump struggles to replace lost heat, the duct air temperature may drop to about 80 degrees F. Air flowing into the living space at this temperature feels uncomfortably cool to the occupants, particularly when the room air temperature has been already gradually decreasing. When the supplemental heat is finally activated, the supply duct air temperature may quickly increase to around 125 degrees F., a much more comfortable temperature, but one that is only available temporarily until the thermostat registers the preset temperature and the secondary heat is deactivated. This can create a very noticeable and uncomfortable 30 to 40 degree F. variation in the supply air temperature coming from the air vents each time the supplemental heat is activated and deactivated.

Besides the discomfort, the conventional pattern of applying supplemental heating reduces overall heat efficiency because it creates extreme temperature stratification. Within minutes of first activating the supplemental heating unit, the duct air temperature might be 50 to 60 degrees F. hotter than the room air. This much warmer air generally does not mix evenly with cooler air in the structure and may not gradually raise the temperature of the living space as intended. Instead, it typically rises directly from the supply vents to the highest levels of the structure where it is often beyond the reach of the occupants and away from the room thermostat. Worse still, this marked stratification further increases temperature differentials across insulated walls and ceilings resulting in more lost heat and reduced efficiency.

U.S. Pat. No. 6,149,066 discloses a method and apparatus for controlling the supplemental heating unit of a heat pump system which involves gradually increasing and decreasing the heat output of the supplemental heating unit to maintain a more consistent supply air temperature. This '066 patent discloses varying the output of a single heating element by switching power on and off using a solid state relay while the remaining elements are switched on and off using electromechanical relays. Power requirements are calculated and applied gradually to the adjustable element to maintain a given duct temperature. If the calculated power requirements exceed the rated output of the adjustable element, then one of the additional fixed output elements is activated and the power to the adjustable output element is varied to meet the new demand in excess of the fixed element. While this arrangement offers some improvements in ease of installation, it has at least two important drawbacks.

First, the '066 patent activates the supplemental heating unit before the second stage call for heat is made. This results in reduced efficiency because both the supplemental heating unit and the heat pump operate simultaneously when it is possible the heat pump might alone be sufficient. Second, by positioning the temperature sensor before the supplemental heating unit, the '066 system maintains an open feedback control loop. It relies solely on estimating the necessary heat output based on a formula rather than using the measured temperature of the air heated by the supplemental heating unit. Without measuring the resulting air temperature after it has been heated by both the heat pump and the supplemental heating unit, actual performance can vary. For example, as the '066 patent points out, the airflow through some systems is known for some fan models but has to be approximated for others. Without this precise information, error is introduced into the formula which causes suboptimal heat output from the supplemental heating unit. Likewise, numerous idiosyncrasies in the heat output of the system are harder to account for without a closed feedback loop to adjust the temperature based on measured rather than estimated results.

What is needed is an inexpensive supplemental heat control system that eliminates wasteful stratification and uncomfortably wide temperature swings while also allowing better control over the temperature of the supply air entering the living space. Such a system would preferably be easy to install with new heat pump systems while also being easily retrofitted to a wide range of existing systems having supplemental resistive heat.

### SUMMARY OF THE INVENTION

The present invention addresses these and other concerns by providing an apparatus for better controlling the power to a supplemental resistive heating element of a new or existing supplemental heating unit to better control the supply air temperature. This better control is based on a sensor positioned downstream from the supplemental heater that is used to provide multilevel control of the average power to the heating element.

When the secondary heat is needed, the present invention partially energizes one of the available heating elements and then begins comparing the temperature of the supply air downstream from the heating element to the controller's preset temperature. It then increases or decreases power to the first heating element as necessary to maintain the desired supply air temperature until the thermostat determines secondary heat is no longer needed. However, if the first element is fully energized, and the supply air temperature is still below the preset temperature, a second element is fully energized with the previous feedback loop continuing as before. If the combination of one fully powered element and one variably powered element is not sufficient to maintain the preset duct temperature, a third element is fully energized and the temperature monitored further. This cycle continues as necessary for as many elements as the supplemental unit has until all available elements are fully energized. In doing so, the present invention better regulates the duct air temperature during periods of supplemental heating thus increasing comfort and efficiency.

The present invention also overcomes cost and complexity difficulties by providing a method for retrofitting the supplemental heating control system to a wide range of existing heat pump systems using supplemental resistive heating units. By providing a temperature sensor positioned near to and downstream from the supplemental heating element, the control system forms a complete feedback loop so that irregularities in the heating elements, line voltage, the flow rate of the blower fans, or changes in the heat output of the indoor coil are compensated for quickly and consistently without manual intervention.

### BRIEF DESCRIPTION OF THE DRAWINGS

FIG. 1 illustrates the preferred embodiment of present invention included in a heat pump system.

FIG. 2 is a diagram depicting selected components of the heat pump system of FIG. 1 and their overall relationship to the supplemental heating unit of FIG. 1.

FIG. 3 is a flow chart for the embodiment of FIG. 1 depicting the logic steps necessary to determine whether or not the supplemental heating unit should be activated or deactivated.

FIG. 4 is a flow chart for the embodiment of FIG. 1 depicting the logic steps necessary to determine whether to incrementally increase or decrease the heat output.

FIG. 5 is a flow chart for the embodiment of FIG. 1 depicting the logic steps necessary to incrementally increase the heat output.

FIG. 6 is a flow chart for the embodiment of FIG. 1 depicting the logic steps necessary to incrementally decrease the heat output.

FIG. 7 is a flow chart for the embodiment of FIG. 1 depicting the steps involved in calculating the size of the next increase or decrease in heat output.

FIG. 8 is a flow chart for the embodiment of FIG. 1 depicting the logic steps necessary to increase or decrease the heat output by the calculated amount.

FIG. 9 is a flow chart for the embodiment of FIG. 1 depicting the logic steps necessary to activate a resistive heating element at full power.

FIG. 10 is a flow chart for the embodiment of FIG. 1 depicting the logic steps necessary to deactivate a resistive heating element.

### DETAILED DESCRIPTION OF THE PREFERRED EMBODIMENTS

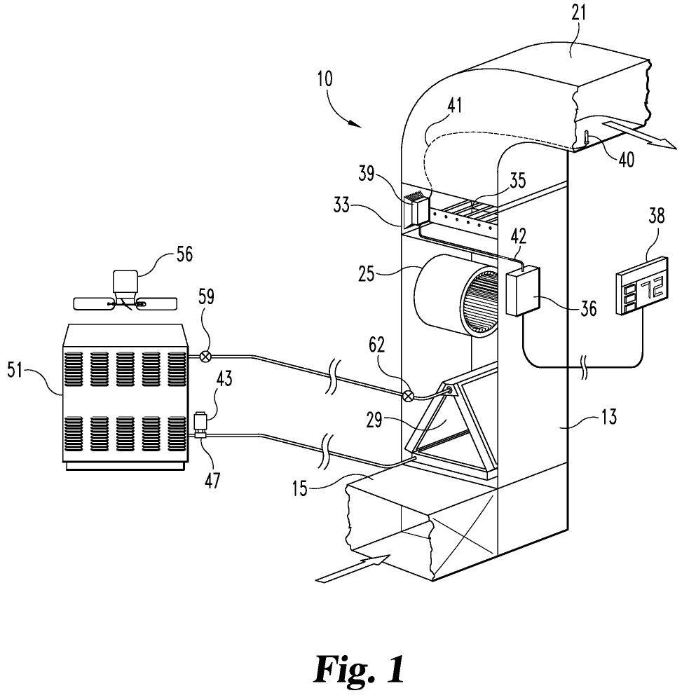

Referring first to FIG. 1, the preferred embodiment of the invention is shown at 10 incorporated into a residential forced air heating unit which has a heat pump as its primary heat source and a resistive heating unit as a secondary heat source. The heating unit is composed of three sections arranged to heat or cool a stream of flowing air: An indoor coil section 13 containing most of the heating and cooling machinery, a return duct 15 which returns upstream cool air from the living space to the heating unit, and a supply duct 21 through which heated air flows downstream back to the living space. Indoor coil section 13, is further subdivided into a blower assembly 25, an indoor coil section 29, and a supplemental heating unit 33. Blower assembly 25 has a blower which draws upstream air from the living space through return duct 15, through indoor coil section 29, and into blower assembly 25. Blower assembly 25 pushes the air out through supplemental heating unit 33 and downstream through supply duct 21 into the living space. A system controller 36 controls the activation and behavior of the system components and changes the system between heating, cooling, and defrost modes as needed. FIG. 1 shows one arrangement of these common components of a residential heating system. However, as one of ordinary skill in the art will appreciate, numerous other arrangements of these basic components are possible and are also within the scope of the invention.

The heat pump system shown in FIG. 1 operates by circulating refrigerant through indoor coil 29 and an outdoor coil 51 which are connected together in a standard closed loop refrigeration circuit whose component parts are controlled by system controller 36. Indoor coil 29 is connected to a compressor 43 which compresses the refrigerant, and a 4-way valve 47 responsible for controlling the direction and rate of flow. The 4-way valve 47 is coupled to outdoor coil 51 which dissipates heat to the outside air aided by a fan 56. Expansion valves 62 and 59 meter the refrigerant flow to indoor coil 29 and outdoor coil 51 respectively. Each of these components is controlled by system controller 36 which manages the movement of heat energy through the circuit.

In the cooling mode, compressor 43 compresses refrigerant into a hot, high-pressure, gas which is directed into outdoor coil 51 by 4-way valve 47. Excess heat is dissipated from the refrigerant when air is pushed through outdoor coil 51 by fan 56. The now cooler refrigerant flows into indoor coil 29 passing first through expansion valve 62. where its pressure drops rapidly causing the refrigerant to change state into a liquid and gas mixture as it enters indoor coil 29. However, as blower assembly 25 pulls warm air from supply duct 15 through indoor coil 29, heat is absorbed by the liquid within the cool refrigerant flowing through indoor coil 29 causing it to evaporate into a gas. The evaporated refrigerant gas passes out of indoor coil 29 back to 4-way valve 47 and into compressor 43 as the now-cooler indoor air moves downstream through supply duct 21 and back into the living space.

In the heating mode, the process operates in reverse. Compressor 43 compresses refrigerant into a hot, high-pressure, gas which is directed into indoor coil 29 by 4-way valve 47 where the excess heat is dissipated into the indoor air in the structure rather than into the outside air. As blower assembly 25 pulls cool air from supply duct 15 through indoor coil 29, the refrigerant condenses to a warm liquid as heat is lost from the refrigerant to warm the indoor air circulating in the living space. The now-cooler liquid then passes through expansion valve 59 where the pressure is reduced creating a liquid and gas refrigerant mix as it enters the outdoor coil 51. Fan 56 is activated as necessary by system controller 36 to force air through outdoor coil 51 to evaporate the cooler liquid refrigerant back into a gas so that it can be recompressed by compressor 43 and the cycle started anew.

If, however, the outside air temperature is too low, outdoor coil 51 will be unable to evaporate the refrigerant liquid to gas fast enough to allow it to be recompressed. As the refrigerant is condensed into a liquid in indoor coil 29 and continues to pass into outdoor coil 56, outdoor coil 56 will have no difficulties evaporating the refrigerant rapidly enough if the outside air temperature remains relatively high—for example above about 30 degrees. However, as air temperatures continue to fall, outdoor coil 51 and fan 56 will be unable to collect heat fast enough to evaporate enough refrigerant liquid to gas. The net result is a refrigeration loop expending more and more energy moving less and less heat while the indoor air temperature continues to drop. The heat pump has now reached a state where it can no longer replace enough heat lost from the structure to maintain the desired indoor temperature without assistance.

The heating unit shown in FIG. 1 provides the necessary assistance using a supplemental heating unit 33 positioned downstream from blower assembly 25 which operates as a secondary heat source. Supplemental heating unit 33 contains one or more resistive heating elements 35 which are very large resistors that generate heat when connected to electricity. Supplemental heating unit 33 includes a control unit 39 that receives input from system controller 36 via control leads 42 notifying it when thermostat 38 is requesting supplemental heat. Control unit 39 controls electric power to each of the resistive heating elements 35 to adjust the overall heat output of supplemental heating unit 33. One resistive heating element 35a is configured for variable output while the remaining resistive heating elements 35b-d are either operating at full power, or not at all. Control unit 39 gradually increases power to the variable output element as necessary. If and when that element operates at or near maximum capacity, an idle resistive heating element 35b-d is activated at full power and the variable element is reset to minimum capacity and adjusted upward as necessary. In like fashion, more resistive heating elements 35b-d are activated as necessary. As the air warms and less heat is required to maintain the proper duct temperature, each full power resistive heating elements 35b-d can be deactivated, being replaced by full power heat output of the variable resistive heating element 35a which can be reduced as necessary to little or no heat output, and then until another full power resistive heating element 35b-d can be deactivated and again replaced by the full power heat output of the variable resistive heating element 35a. That process continues until no more supplemental heat is needed. In this manner, supplemental heating unit 33 assists the heat pump in efficiently bringing the indoor air temperature back to a comfortable level while maintaining comfortable duct air temperatures.

Control unit 39 regulates the required heat output using data from a temperature sensor 40 which is independent of thermostat 38 and is connected to control unit 39 by sensor lead 41. Temperature sensor 40 is positioned in supply duct 21 downstream from supplemental heating unit 33 to provide constant feedback of the actual duct air temperature. This feedback allows control unit 39 to precisely vary power to the variable resistive heating element 35a and to properly sequence the activation and deactivation of the other resistive heating elements 35b-d to maintain a preset duct air temperature. Temperature sensor 40 is therefore preferably positioned near to supplemental heating unit 33 for ease of maintenance and installation, yet far enough downstream from supplemental heating unit 33 in the flow of heated air to avoid false readings caused by heat radiating directly from resistive heating elements 35.

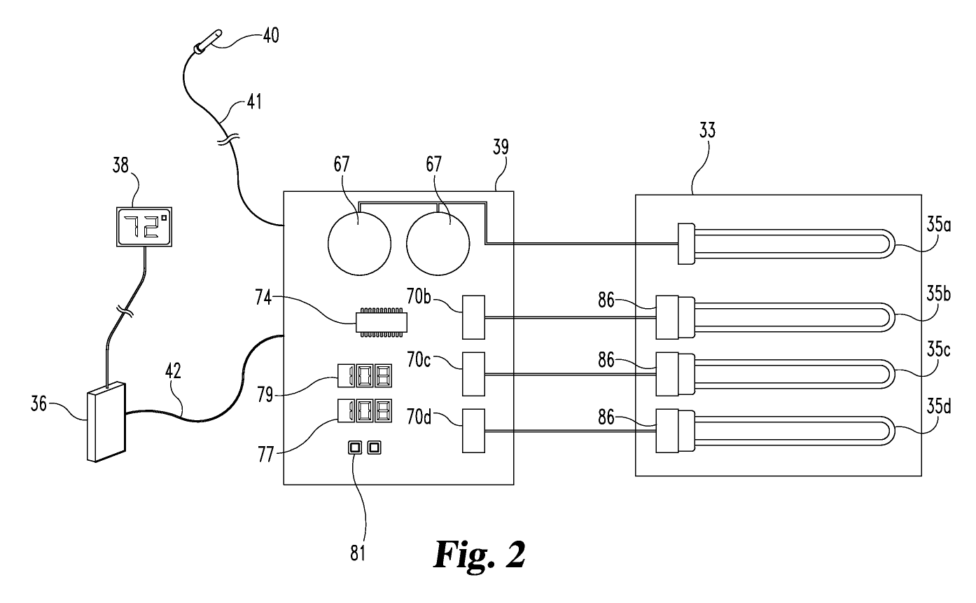

A schematic view of control unit 39 is shown in FIG. 2. Control unit 39 includes one or more solid state switches 67 capable of rapidly switching alternating current such as a silicon-controlled rectifier (SCR). FIG. 2 also shows switches having mechanical contacts for switching power at a substantially slower rate appearing as conventional mechanical relays 70b-d. A control circuit 74 appears in FIG. 2 as a single integrated circuit microprocessor having an internal memory store which is programmed to handle all logic decisions pertaining to the switching of mechanical relays 70b-d and solid state switches 67. A preset temperature display 77 for displaying the current preset temperature appears next to a sensor temperature display 79 for displaying the downstream air temperature measured by temperature sensor 40. Preset temperature display 77 and sensor temperature display 79 are both embodied in FIG. 2 as a set of three light emitting diode (LED) 7-segment display devices.

A temperature input device 81 for setting the preset temperature is adjacent to preset temperature display 77 and consists of two buttons: Pressing one button increases the preset temperature while pressing the other button decreases the preset temperature. The preset temperature is stored after entry, preferably in a nonvolatile memory. Alternatively one could use a knob with associated temperature indicia to rotate a potentiometer or encoder to set the preset temperature. Other alternatives could use a numeric keypad or a touch-screen liquid crystal display (LCD). Preferably the preset temperature is at least 90 degrees F., more preferably it is at least 100 degrees F., and most preferably it is as shown in FIG. 2, 108 degrees F.

In the preferred embodiment, two solid state switches 67 are indicated and connected in parallel to divide the power load between them. This connection allows solid state switches 67 to gradually vary the average power dissipated by the variable output resistive heating element 35a while the other resistive heating elements 35b-d are each controlled by a single mechanical relay 70b-d, respectively. Each mechanical relay 70b-d is connected to an individual sequencer 86 which is coupled to a single resistive heating element 35b-d. Each sequencer 86 operates in the conventional manner to prevent resistive heating elements 35b-d from drawing excessive initial current by energizing simultaneously. Resistive heating elements 35a-d are preferably all of the same output rating but they can be of different output ratings, such as with binary relationships, such that different combinations can achieve any value over a broader range of values, 1×, 2×, and 4× the power of the variable resistor, respectively, depending on the implementation most desirable.

When remote thermostat 38 calls for supplemental heat, control unit 39 responds by gradually increasing the average power to the variable output resistive heating element 35a. The preferred method for gradually increasing the average power is to increase the percentage of time the variable resistive heating element 35a is connected to power. Alternating current switches polarity 50 or 60 times per second (depending on the geographical location of the power source). Control unit 39 exploits this behavior by incorporating circuitry that opens and closes solid state switches 67 when the voltage crosses zero volts. This allows the control unit 39 to efficiently and rapidly connect and disconnect the variable output resistive heating element 35a to power as much as a 120 times per second while connecting and disconnecting the other heating elements to power using mechanical relays far less frequently. In the preferred embodiment solid state switches 67 switch on and off rapidly, perhaps 120 times per second, or alternatively every 10 seconds if there is sufficient residual heat retained by the resistor such that temperature variations are smoothed and are not noticeable to a person standing by a duct outlet. In theory, mechanical relays could be used in place of solid state switches 67 and switched very rapidly to achieve a similar result. However, arcing across the air gap between the relay contacts will usually result in excessive wear on the contacts and overheating of the relay coil possibly resulting in premature failure at such high switching rates. To minimize these problems, contact damage from arcing might be reduced by using platinum coated contacts or sealed vacuum relays in place of air gap relays, although neither of these approaches is optimal. Problems with switching might be avoided altogether by using a servo controlled autotransformer or the like to vary the average power delivered to the variable resistive heating element 35a by varying the voltage rather than the duty cycle for connection to power. Other alternatives could be used as well to simulate a continuously variable resistor working along with slowly-switched, relay controlled resistors.

In the preferred embodiment, by rapidly switching the power to resistive heating element 35a, control unit 39 is able to approximate a wide range of lower heat outputs using existing equipment. If for any given 100 voltage cycles, control unit 39 only allows half the voltage cycles to reach resistive heating element 35a, then it will only deliver half its rated capacity. Because variable resistive heating element 35a is powered only a fraction of the time, it does not reach its full rated heat output. Instead it reaches and maintains a nearly constant intermediate temperature depending on the percentage of time it is connected to power. However, given that different resistive heating elements may be used as element 35a, it very difficult to predict how much power to supply without also sampling the resulting air temperature downstream to determine if the resistive heating element has been connected to power for the proper percentage of time to achieve the desired duct temperature.

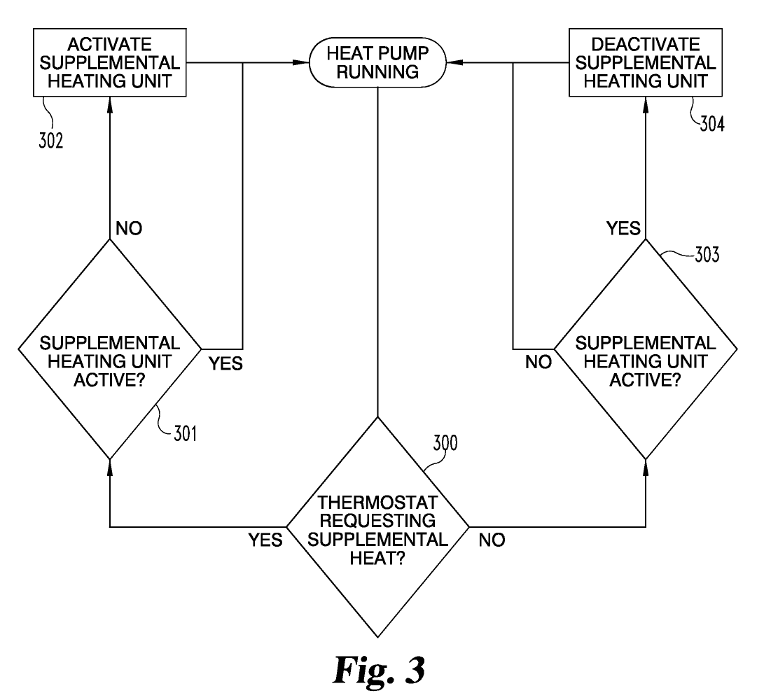

FIG. 3 through FIG. 10 give details regarding various embodiments of the control logic used to vary the heat generated by the secondary heat source. FIG. 3 shows the logic system controller 36 executes to activate and deactivate supplemental heating unit 33. The process begins with the heat pump running. System controller 36 notes whether indoor thermostat 38 has reached its second set point and is requesting supplemental heat (step 300). If so, supplemental heating unit 33 is activated (step 302) if it has not been activated already (step 301). If indoor thermostat 38 is not requesting supplemental heat (meaning the indoor temperature is now above the second set point), and supplemental heating unit 33 is already active (step 303), then supplemental heat is no longer needed and supplemental heating unit 33 should be deactivated (step 304). If steps 300 and 303 are both false, then no supplemental heat is needed. In any event, the end state is the same as the beginning state: The heat pump is running with system controller 36 again waiting for indoor thermostat 38 to request supplemental heat.

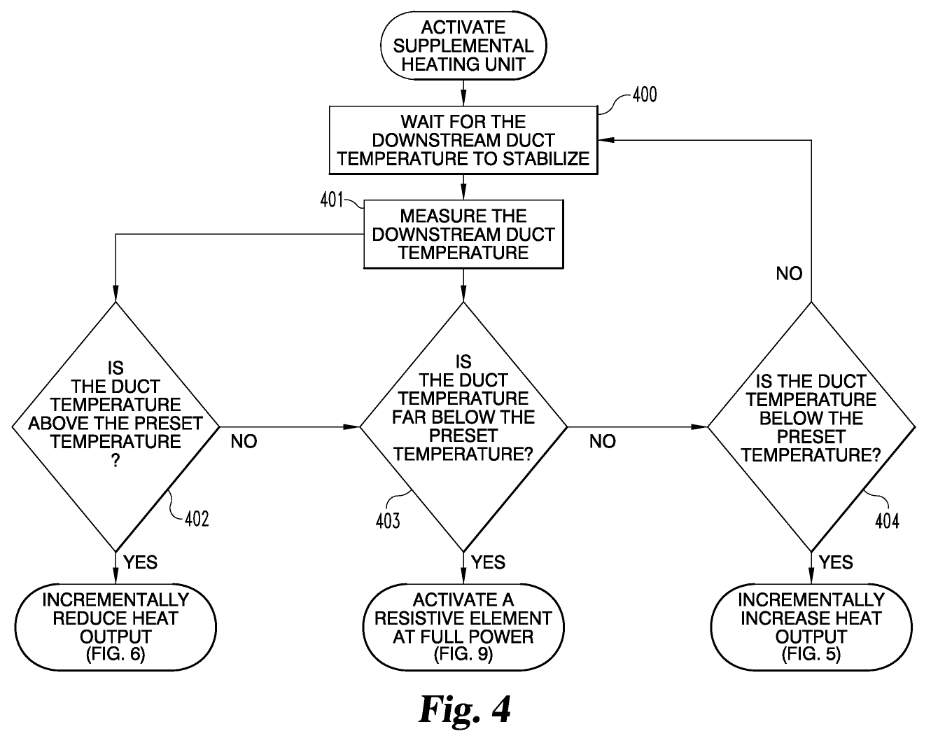

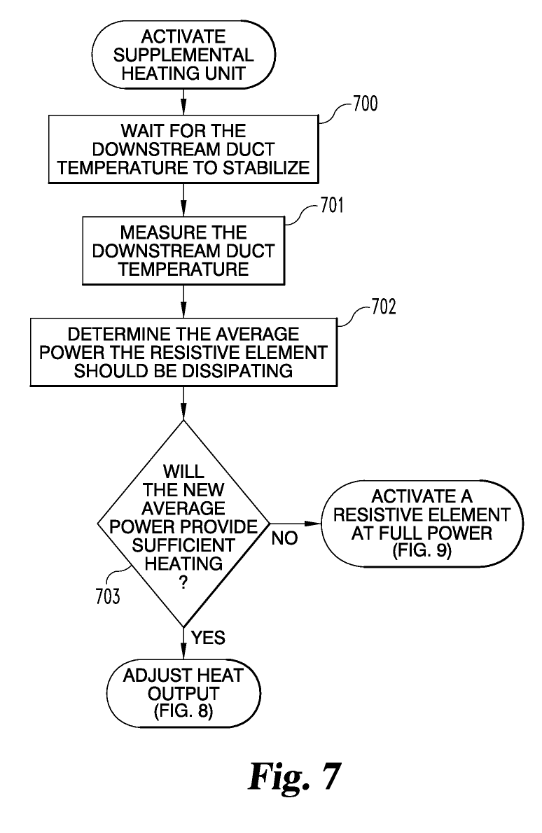

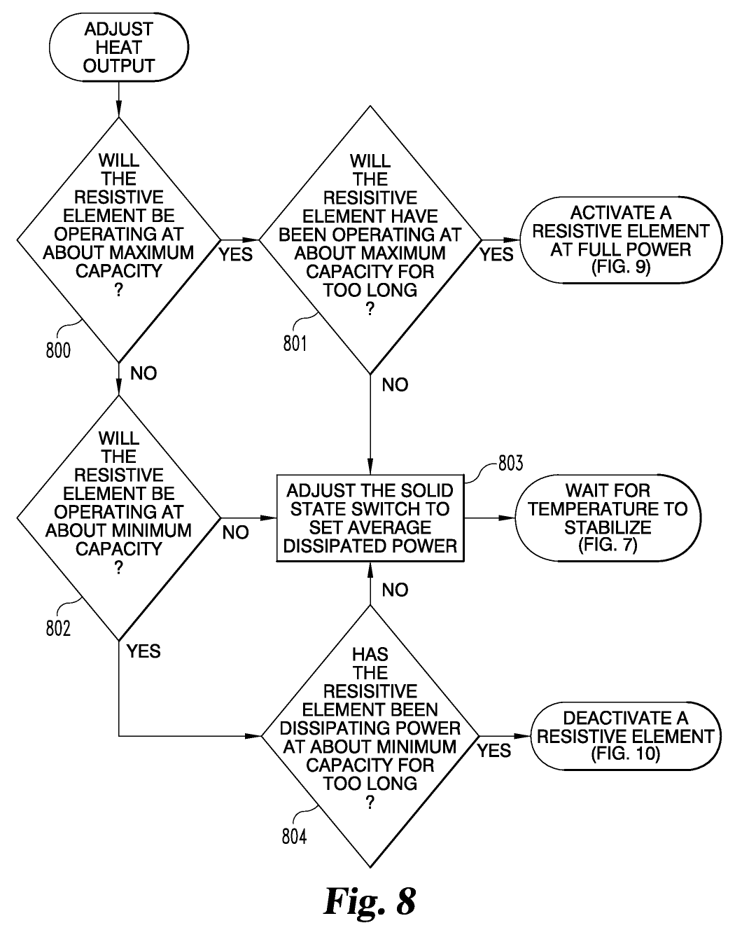

FIG. 4 through FIG. 6 indicate one embodiment of the control logic necessary to increase or decrease the percentage of time solid state switches 67 supply power in an incremental fashion while FIG. 7 and FIG. 8 shows a second embodiment that uses an algorithm to compute a new percentage of time rather than applying an incremental increase or decrease.

In FIG. 4, the process begins when supplemental heating unit 33 is activated (see FIG. 3 step 302). In this embodiment, control circuit 74 waits for the duct temperature to stabilize (step 400) before taking a reading from temperature sensor 40 (step 401). If the duct temperature at temperature sensor 40 is above the preset temperature (step 402), then the heat output of supplemental heating unit 33 is incrementally reduced. However, if the duct air temperature is not above the preset temperature (step 402), but is far below the desired duct temperature (step 403), then control circuit 74 will immediately activate an available resistive heating element 35b, c or d at full power rather than making an incremental increase in the heat output of the variable output resistive heating element 35a. Step 403 allows the incremental embodiment to reach the necessary output level faster in cases where the indoor temperature is much lower than the preset temperature. This would occur, for example, when the occupants of a home sharply increase the first set point of indoor thermostat 38 which was kept inordinately low to conserve energy in their absence. On the other hand, if the duct temperature is not far below the preset temperature (step 403), then control circuit 74 determines if it is below the preset temperature at all (step 404). If so, the heat output of supplemental heating unit 33 is only incrementally increased. If not, control circuit 74 returns to step 400 and repeats the cycle having concluded supplemental heating unit 33 is already producing enough heat.

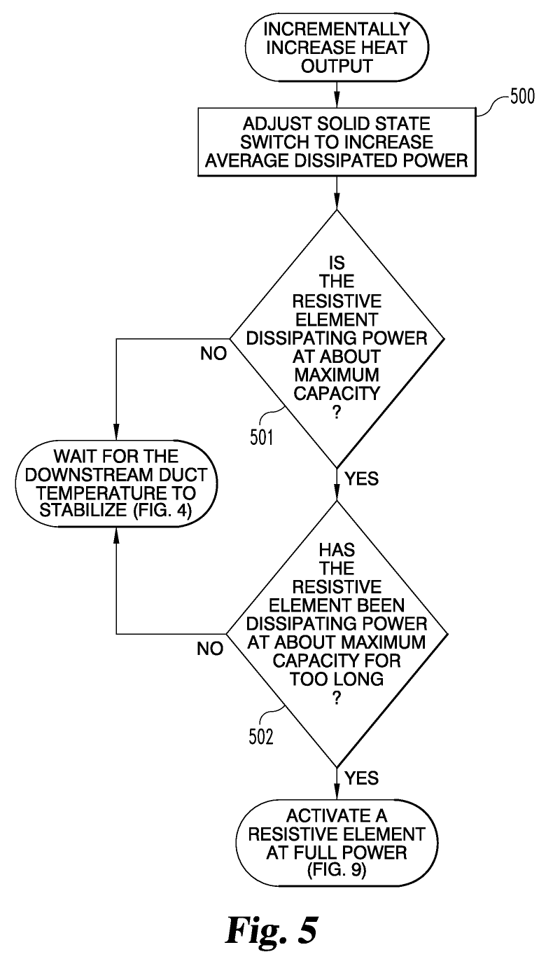

The steps required to incrementally increase the heat output are shown in FIG. 5. In this embodiment, control circuit 74 maintains a set increment applied to the average power dissipated by resistive heating element 35a each time the heat output is increased. When an incremental increase in heat output is required (see FIG. 4, step 404), control circuit 74 applies the incremental increase to the average power dissipated by the variable element and stores this new value, preferably in nonvolatile memory, as the current average power (step 500). In the preferred embodiment, the average power is used by control circuit 74 to generate a timing sequence indicating when voltage will be supplied to the variable output resistive heating element 35a. At this point, resistive heating element 35a begins to receive power more often than before and is increasing its heat output, even if only by a very slight amount.

Next, control circuit 74 determines whether the new average power dissipated is about maximum capacity (step 501). In this embodiment, the preferred technique for determining this is to determine if the variable output resistive heating element 35a is connected to power about 100 percent of the time. If not, then the adjustment process is complete and control unit 39 waits for the duct temperature measured by temperature sensor 40 to stabilize at the new increased temperature before taking a new measurement and determining whether to make further adjustments (see FIG. 4, step 400). However, if the incremental increase has resulted in power dissipating at about full capacity, control circuit 74 will next determine if this has been the case for some time or is merely a momentary spike in heat demand. If the average power has been about maximum capacity for only a short period of time, then control circuit 74 will continue with the average power at this high level. However, if the average power dissipated has remained at maximum capacity for too long, control circuit 74 will energize another inactive resistive heating element 35b, c or d if one is available.

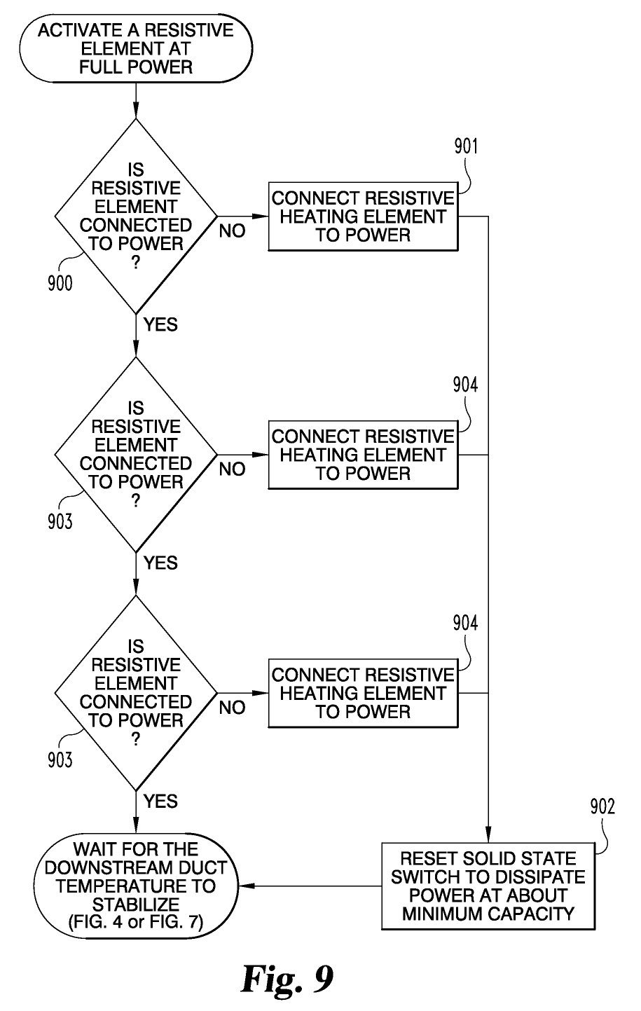

Control circuit 74 activates a resistive heating element 35b according to the logic steps outlined in FIG. 9. Control circuit 74 first checks if the first relay-controlled resistive heating element 35b is active (step 900). If not, the corresponding relay 70b is activated causing power to flow to sequencer 86 and resistive heating element 35b resulting in a fully energized heating element (step 901). Control circuit 74 then resets the average power dissipated by the variable output element 35a to about minimum capacity at about the same time (step 902) so that when the temperature finally stabilizes afterwards (see FIG. 4., step 400), the heat output from the supplemental heating unit 33 is essentially unchanged except now more heat can be added gradually to the newly energized resistive heating element 35b operating at full power. On the other hand, as indicated in FIG. 9, if the first relay-controlled resistive heating element is already active (step 900), the same check is made for the next element resistive heating element 35c (step 903). If the second is not active, it is activated in step 904, and so on for the third element resistive heating element 35d in steps 905 and 906. Although FIG. 9 shows logic for only 3 elements, the same logic would be repeated for every relay-controlled resistive heating element 35 contained in supplemental heating unit 33.

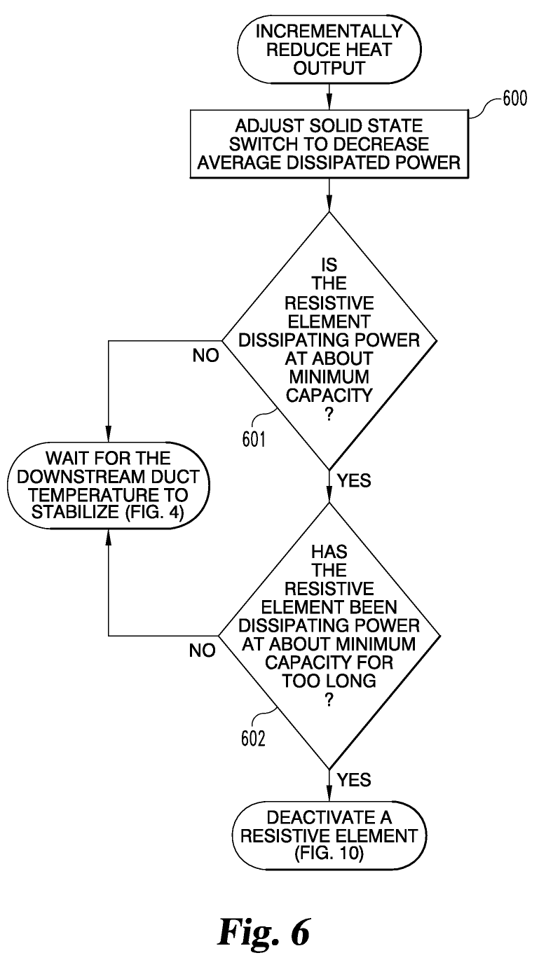

Similar logical operations occur in control circuit 74 to incrementally reduce the heat output of supplemental heating unit 39 as shown in FIG. 6. Control circuit 74 maintains a set increment subtracted from the average power each time the heat output is decreased. This increment can be either the same value added to the average power in FIG. 5 step 500, or it can be a different value. For example, heat output could be increased at each step by 5 percent of the heating element's rated power and decreased by 2 percent or vice versa. In any case, when an incremental decrease in heat output is required (see FIG. 4, step 402), control circuit 74 subtracts the appropriate value from the current average power and stores the resulting value as the new current average power (step 600). Again, the final result is preferably a timing sequence indicating when power will be delivered to variable output resistive heating element 35a. Next, control circuit 74 determines whether the new average power is about minimum capacity (step 601). If not, then the adjustment process is complete and control unit 39 waits for the duct temperature measured by temperature sensor 40 to stabilize at the new decreased temperature before taking further measurements and determining whether to make further adjustments (see FIG. 4, step 400).

On the other hand, if the reduction in heat output has caused solid state switches 67 to operate at about minimum capacity, control circuit 74 will next determine if this has been the case for some time or is merely a momentary reduction in heat demand. If the average power dissipated has been at minimum capacity for only a short period of time, then control circuit 74 will continue with the average power at this low level for some time longer. However, if the average power has remained this low for too long, control circuit 74 will deactivate a resistive heating element 35b-d if any are active.

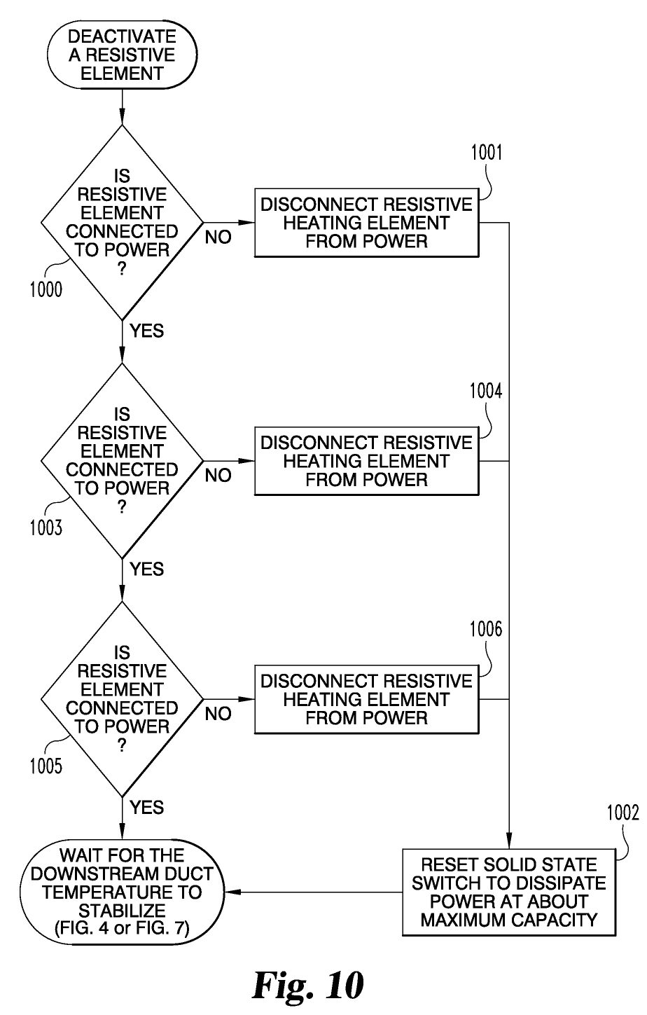

Control circuit 74 deactivates a resistive heating element 35b-d according to the steps outlined in FIG. 10. Control circuit 74 determines if the third resistive heating element 35d is active (step 1000). If so, the corresponding relay 70d is deactivated causing resistive heating element 35d to cease heating (step 1001). Control circuit 74 then resets the average power output of the variable output resistive heating element 35a to about maximum capacity at about the same time (step 1002) so that when the temperature finally stabilizes (see FIG. 4., step 400), the heat output from the supplemental heating unit 33 is essentially unchanged except now heat can be gradually reduced from its previous level. However, as indicated in FIG. 10, if the third resistive heating element 35d is already inactive (step 1000), the same check is made of the second element resistive heating element 35c (step 1003). If the second is inactive, the first element 35b is deactivated if it is active in steps 1005 and 1006. Although FIG. 10 shows logic for only 3 elements, the same logic would be repeated for every resistive heating element 35 contained in supplemental heating unit 33.

FIG. 7 describes another approach to calculating adjustments in the average power dissipated by the variable element where the size of each adjustment to the average power is calculated. Rather than apply the same incremental increase or decrease, this embodiment calculates the prospective change before applying it. The process in FIG. 7 is similar to FIG. 4 but with some important differences. Control circuit 74 waits for the temperature to stabilize (step 700), takes a temperature reading from temperature sensor 40 (step 701), then calculates the new average power (step 702), and determines if the new average power will provide enough heat to raise the downstream duct temperature to the preset temperature. If not, control circuit 74 activates a resistive heating element at full power as already discussed (See FIG. 9). If the calculation results in a need for more heat than the variable output resistive heating element 35 can provide, then a resistive heating element 35b, c or d should be energized at full power. On the other hand, if the calculation determines the preset duct temperature can be satisfied with less than a full power resistive heating element 35, control circuit 74 adjusts the heat output of element 35a using the newly calculated value.

The newly calculated average power can be arrived at in a wide variety of ways. In one embodiment, a table of values is preloaded into a nonvolatile memory portion of control circuit 74 during manufacturing, installation, or even afterward as a firmware upgrade. In step 702, control circuit 74 calculates the difference between the temperature measured by temperature sensor 40 and the preset temperature entered via temperature input device 81. Control circuit 74 then passes the difference between these two values through a hashing algorithm that yields a key. The key is used as an index into the preloaded table of values. The value at the indexed location in the table is then used as the next percentage of time the variable output resistive heating element 35 will be connected to power. This value is then preferably computed as a timing sequence indicating precisely when solid state switches 67 are to switch power on and off to resistive heating element 35. This solution provides a fast, efficient, and easily modified algorithm for determining from the current duct temperature what the next average dissipated power should be. The table of values can be as large or as small as circumstances require, and time and materials allow. The values can be minimal or extensive in number and populated by various means such as computer modeling or experimentation. They can be further modified to account for variations like human comfort or particular building anomalies.

Other algorithms can be employed in step 702. In another embodiment, control circuit 74 is a microprocessor programmed to calculate average power based on the current average power, the current duct temperature, and the rate of change of the duct temperature over the recent past. In yet another embodiment, other variables are considered as well like indoor humidity which is a significant factor in the perceived comfort level. Other embodiments take into account outdoor temperature, and temperatures at various locations in the structure in determining power to the variable output element. Numerous variations are possible, especially if control circuit 74 includes or is implemented using a microprocessor that is reprogrammable.

Once the new average power has been calculated as shown in FIG. 7, the heat output is adjusted as shown in FIG. 8. First, control circuit 74 determines if the variable resistive heating element 35a will be operating at about maximum capacity (step 800). Next, control circuit 74 determines if setting the power dissipated to maximum capacity now will result in resistive heating element 35a having operated at maximum capacity for too long (step 801). To determine this, control circuit 74 checks to see if it has already been operating at maximum capacity and if so, for how long. If applying the proposed power adjustment means resistive heating element 35a would have been operating at about maximum capacity for too long, then another resistive heating element 35b, c or d should be immediately activated using a mechanical relay (See FIG. 9). If maximum capacity is required, but it will not have been for too long, then the new average power calculated in FIG. 7 will be set (step 803). In the preferred embodiment, a timing pattern would then be computed indicating the precise sequencing of power to the variable output resistive heating element 35. The power would then begin to flow accordingly and the heat output would likewise begin to change toward the new target level.

On the other hand, if the new power setting will not cause resistive heating element 35a to operate at about maximum capacity, then control circuit 74 will determine if the new power setting will cause it to operate at about minimum capacity. If not, then the new average power calculated in FIG. 7 will be set (step 803) and resistive heating element 35a will begin to adjust its heat output accordingly. However, if near minimum capacity will be the result, then control circuit 74 must determine if the variable output resistive heating element 35a has been dissipating power at about minimum capacity for too long (step 804). As discussed above regarding maximum capacity, the control circuit must determine if resistive heating element 35a has been operating at about minimum capacity and if so, for how long. If continuing to operate at about minimum capacity now would mean operating that way too long, then a full power resistive heating element 35b, c or d should be deactivated to reduce heat output if possible (See FIG. 10). If not, then the new average power calculated in FIG. 7 will be set as described above.

While the invention has been illustrated and described in detail in the drawings and foregoing description, the same is to be considered as illustrative and not restrictive in character, it being understood that only one embodiment has been shown and described and that all changes, equivalents, and modifications that come within the spirit of the inventions defined by the following claims are desired to be protected.

What is claimed is:

1. A heating unit comprising:
A heat pump controlled by a remote thermostat;
A secondary heat source having a first and second resistor;
A first connecting switch having mechanical contacts that connects and disconnects the first resistor to power;
A second connecting solid state switch that connects and disconnects the second resistor to power at a substantially more rapid rate than the first connecting switch;
A temperature sensor independent of the remote thermostat positioned near to and downstream from the secondary heat source, and;
A control unit responsive to the temperature sensor for controlling power to the resistors.

2. The heating unit of claim 1 in which the control unit also has a preset temperature.

3. The heating unit of claim 2 in which the control unit also has a device for setting the preset temperature.

4. The heating unit of claim 2 in which the control unit also has a device for displaying the current preset temperature.

5. The heating unit of claim 1 in which the control unit also has a device for displaying a downstream air temperature measured by the temperature sensor.

6. The heating unit of claim 1 in which the control unit also has:
A secondary heat source of claim 1 further comprising a third and fourth resistor;
A third connecting switch having mechanical contacts that connects and disconnects the third resistor to power, and;
A fourth connecting switch having mechanical contacts that connects and disconnects the fourth resistor to power.

7. The heating unit of claim 1 in which the control unit connects the first switch when the second resistor is dissipating power at about maximum capacity for greater than a first period of time, and disconnects the first switch when the second resistor has been dissipating power at about minimum capacity for greater than a second period of time.

8. The heating unit of claim 2 where the control unit keeps a downstream air temperature at the temperature sensor near to the preset temperature by increasing the average power dissipated by the second resistor by a first amount when the downstream temperature drops below the preset temperature by more than a first threshold, and decreasing the average power dissipated by the second resistor by a second amount when the downstream temperature is above the preset temperature by more than a second threshold.

9. The heating unit of claim 2 where the control unit keeps a downstream air temperature at the temperature sensor near the preset temperature by selecting adjustments to the average power dissipated by the second resistor from a collection of adjustments.

10. The heating unit of claim 9 where the adjustment is selected based on the difference between the downstream air temperature and the preset temperature.

11. The heating unit of claim 2 where the control unit uses a downstream air temperature at the temperature sensor, the power dissipated by the second resistor, and the rate of change of the downstream air temperature to calculate adjustments to the average power dissipated by the second resistor.

12. The heating unit of claim 1 where the temperature sensor is independent of the remote thermostat and is positioned in a duct downstream from the secondary heat source.

13. A heating unit comprising:
A heat pump controlled by a remote thermostat;
A secondary heat source having a first and second resistor;
A first connecting switch having mechanical contacts that connects and disconnects the first resistor to power;
A second connecting solid state switch that connects and disconnects the second resistor to power at a substantially more rapid rate than the first connecting switch;
A temperature sensor independent of the remote thermostat positioned in a duct downstream from the secondary heat source, and;
A control unit responsive to the temperature sensor for controlling power to the resistors.

14. The heating unit of claim 13 in which the control unit also has a preset temperature.

15. The heating unit of claim 14 in which the control unit also has a device for setting the preset temperature. The heating unit of claim 1 in which the control unit also has:
A secondary heat source of claim 1 further comprising a third and fourth resistor;
A third connecting switch having mechanical contacts that connects and disconnects the third resistor to power, and;
A fourth connecting switch having mechanical contacts that connects and disconnects the fourth resistor to power.

16. The heating unit of claim 13 in which the control unit connects the first switch when the second resistor is dissipating power at about maximum capacity for greater than a first period of time, and disconnects the first switch when the second resistor has been dissipating power at about minimum capacity for greater than a second period of time.

17. The heating unit of claim 14 where the control unit keeps a downstream air temperature at the temperature sensor near to the preset temperature by increasing the average power dissipated by the second resistor by a first amount when the downstream temperature drops below the preset temperature by more than a first threshold, and decreasing the average power dissipated by the second resistor by a second amount when the downstream temperature is above the preset temperature by more than a second threshold.

18. The heating unit of claim 14 where the control unit keeps a downstream air temperature at the temperature sensor near the preset temperature by selecting adjustments to the average power dissipated by the second resistor from a collection of adjustments based on the difference between the downstream air temperature and the preset temperature.

19. The heating unit of claim 14 where the control unit uses a downstream air temperature at the temperature sensor, the power dissipated by the second resistor, and the rate of change of the downstream air temperature to calculate adjustments to the average power dissipated by the second resistor.

20. A method of installing a second control unit for a supplemental resistive heating unit of a heat pump system having an operating first control unit for controlling power to a resistor, the second control unit having a solid state switch for rapidly varying the time the resistor is connected to power from about 0 percent of the time to about 100 percent of the time so as to provide different effective rates of heating, the method steps comprising:
Coupling the switch of the second control unit to the resistor;
Positioning a temperature sensor downstream from the resistor, and
Coupling the temperature sensor to the second control unit.
